(19) United States
(12) Patent Application Publication
(10) Pub. No.: US 2005/0279594 A1
(43) Pub. Date: Dec. 22, 2005

(54) Floating type disk brakes

(76) Inventor: Hironobu Saka, Nagoya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/157,979

(22) Filed: Jun. 22, 2005

(30) Foreign Application Priority Data
Jun. 22, 2004 (JP) 2004-183535

(51) Int. Cl. F16D 65/14

(52) U.S. Cl. 188/218 XL

(57) ABSTRACT

A floating type disk brake has an inner pad and an outer pad for pressing against axially opposing surfaces of the brake disk by the actuation of a piston. The ratio of an outer circumferential region to the inner circumferential region of the outer pad is greater than a ratio of the same for the inner pad. In addition to or alternatively, the ratio of the length of the outer circumferential edge to the inner circumferential edge of the outer pad is greater than a ratio of the same for the inner pad. In addition to or alternatively, an angle of intersection of the radial lines extending along the rotation-in-side edge and the rotation-out-side edge of the outer pad is greater than an angle of intersection of the same for the inner pad.

This application claims priority to Japanese patent application serial number 2004-183535, the contents of which are incorporated herein by reference.

### BACKGROUND OF THE INVENTION

1. Field of the Invention

The present invention relates to disk brakes, and in particular to disk brakes that are known as floating type disk brakes.

2. Description of the Related Art

In general, floating type disk brakes have a caliper disposed on an outer peripheral side of a brake disk and straddle the brake disk in an axial direction. An inner pad is pressed against an inner surface of the brake disk by a piston disposed on the inner side of the caliper. An outer pad is pressed against an outer surface of the brake disk by a caliper claw. The caliper claw is formed on the outer side of the caliper and moves via a reaction force generated by the piston when the piston is operated to press the inner pad. The caliper claw extends in a cantilever manner from a position on the outer peripheral side of the brake disk toward the central axis of the brake disk

In a typical floating type disk brake, an inner pad and an outer pad are made of friction members having identical configurations. In another floating type disk brake, as disclosed in U.S. Pat. No. 4,220,223, an inner pad and an outer pad are made of friction members having different configurations from each other.

In the brake disk of the above U.S. patent, the friction member of the inner pad has chamfered portions on opposite sides in the rotational direction of a brake disk, and has a slide contacting surface at a central portion. The slide contacting surface has a substantially sectoral configuration, so that the area of the slide contacting surface increases in a direction toward the outer peripheral side. Therefore, a pressure per unit area applied to the brake disk decreases in the direction toward the outer peripheral side, so that an increase in the amount of abrasion at the outer peripheral side can be suppressed. As a result, potential non-uniform abrasion may be suppressed. On the other band, the outer pad does not have chamfered portions nor have a sectoral slide contacting surface.

The inner pad and the outer pad may exhibit different abrasion tendencies from each other. Thus, it is likely that the inner pad is pressed at the central portion by the piston and that the outer pad is pressed at a position opposing the caliper claw that extends in a cantilever manner. If the caliper claw has pressed the outer pad with a strong force, a possibility may exist that the caliper claw is warped its base end. When this occurs, the base end of the caliper claw may primarily press the outer pad so that a stronger pressing force may be applied by the outer pad at a region located on an outer peripheral side of the brake disk Therefore, the amount of abrasion at the outer peripheral side of the outer pad may be larger than that at the inner peripheral side. Therefore, the tendency of non-uniform abrasion with respect to the radial direction of the brake disk is stronger in the outer pad than in the inner pad.

A floating type disk brake that may suppress such non-uniform abrasion of the outer pad has not been previously developed.

### SUMMARY OF THE INVENTION

It is accordingly an object of the present invention to teach a floating type disk brake that can suppress the non-uniform abrasion of an outer pad.

In one aspect of the present teachings, disk brakes are taught that include a brake disk and a caliper disposed on the radially outer side of the brake disk and extending in an axial direction of the brake disk, substantially straddling the brake disk. A piston is disposed on a first side (e.g., an inner side with respect to a vehicle body) of the caliper with respect to the axial direction of the brake disk. A first pad (e.g., an inner pad) is adapted to be pressed against a first axial surface (e.g., an axially inner surface) of the brake disk by the actuation of the piston. At least one caliper claw is disposed on a second axial side (e.g., an axially outer side) of the caliper and is movable with the caliper via a reaction force produced when the piston is actuated. A second pad (e.g., an outer pad) is adapted to be pressed against a second axial surface (e.g., an axially outer surface) of the brake disk opposite to the first axial surface through the movement of the at least one caliper claw. The at least one caliper claw extends in a cantilever manner in a direction from an outer circumferential side of the brake disk toward a central side of the brake disk in a cantilever manner. The first and second pads respectively have slide contact surfaces for contacting with the first and second axial surfaces of the brake disk.

In one embodiment, each of the slide contact surfaces has an outer circumferential region and an inner circumferential region delimited by a central circumferential line passing through a central point with respect to the circumferential direction and also with respect to the radial direction of the corresponding pad. The outer circumferential region is greater than the inner circumferential region. The ratio of the outer circumferential region to the inner circumferential region of the second pad is greater than the ratio of the outer circumferential region to the inner circumferential region of the first pad.

In general, the contact area of a brake disk with an outer circumferential region of a slide contact surface of an inner or outer pad is greater than the contact area of an inner circumferential region of the slide contact surface due to the change in length in the circumferential direction of the brake disk in the radial direction.

However, in the above arrangement, the outer circumferential region of the slide contact surface is greater than the inner circumferential region. In other words, the pressure per unit area applied by the outer circumferential region may be smaller than the pressure per unit area applied by the inner circumferential region. Therefore, the amount of abrasion per unit area of the outer circumferential region may be substantially equal to the amount of abrasion per unit area of the inner circumferential region. As a result, non-uniform abrasion of the slide contact surface with respect to the radial direction of the brake disk can be prevented or minimized.

In addition, the caliper claw(s) used for pressing the outer pad against the brake disk extend in a cantilever manner. Therefore, during the application of a pressing force to the second pad the caliper claw(s) may tend to warp about the base ends on the side of the caliper. As a result, the outer circumferential region of the second pad may be pressed against the brake disk by a greater force than the inner circumferential region. However, according to the above arrangement, the ratio of the area of the outer circumferential region to the area of the inner circumferential region of the second pad is greater than the ratio of the area of the outer circumferential region to the area of the inner circumferential region of the first pad. Therefore, the pressure per unit area applied by the outer circumferential region may be reduced so as to prevent or minimize non-uniform abrasion, even if the caliper claws have been warped. As a result, non-uniform abrasion of the second pad may be prevented or at least minimized to the same extent as the non-uniform abrasion that may be caused in the first pad, if any. In other words, non-uniform abrasion of the second pad may be reduced to at least the same extent as in the first pad.

In another embodiment, the outer circumferential region has an outer circumferential edge, and the inner circumferential region has an inner circumferential edge. The length of the outer circumferential edge is longer than the inner circumferential edge in each of the first and second pads. The ratio of the length of the outer circumferential edge to the inner circumferential edge of the second pad is greater than the ratio of the length of the outer circumferential edge to the inner circumferential edge of the first pad.

In the above arrangement, the length of the outer circumferential edge of the slide contact surface is longer than the length of the inner circumferential edge. Therefore, the pressure per unit area applied by the outer circumferential region may be smaller than the pressure per unit area applied by the inner circumferential region. As a result, also with this arrangement, non-uniform abrasion of the slide contact surface with respect to the radial direction of the brake disk can be prevented or minimized.

In addition, because the ratio of the length of the outer circumferential edge to the inner circumferential edge of the second pad is greater than the ratio of the length of the outer circumferential edge to the inner circumferential edge of the first pad, the pressure per unit area applied by the outer circumferential region may be reduced to prevent or minimize non-uniform abrasion, even if the caliper claws have been warped. As a result, also with this arrangement non-uniform abrasion of the second pad may be prevented or at least minimized to the same extent as the non-uniform abrasion that may be caused in the first pad, if any.

In a further embodiment, each of the slide contact surfaces has a first side edge (e.g., a rotation-in-side edge) and a second side edge (e.g., a rotation-out-side edge) disposed on opposite sides of the slide contact surface in a circumferential direction. The first and second side edges extend along radial lines extending substantially in a radial direction and intersecting with each other at a point radially inward of the corresponding slide contact surface. The angle of intersection of the radial lines extending along the first and second side edges of the second pad is greater than an angle of intersection of the radial lines extending along the first and second side edges of the first pad.

In the above arrangement, the first and second side edges extend along radial lines extending substantially in a radial direction and intersecting at a point radially inward of the corresponding slide contact surface. Thus, the slide contact surface may have a substantially sectoral configuration. Therefore, the pressure per unit area applied by the outer circumferential region may be smaller than the pressure per unit area applied by the inner circumferential region. As a result, also with this arrangement non-uniform abrasion of the slide contact surface with respect to the radial direction of the brake disk can be prevented or minimized.

In addition, because the angle of intersection of the radial lines extending along the first and second side edges of the second pad is greater than an angle of intersection of the radial lines extending along the first and second side edges of the first pad, the pressure per unit area applied by the outer circumferential region may be reduced to prevent or minimize non-uniform abrasion, even if the caliper claws have been warped. As a result, also with this arrangement non-uniform abrasion of the second pad may be prevented or at least minimized to the same extent as the non-uniform abrasion that may be caused in the first pad, if any.

### BRIEF DESCRIPTION OF THE DRAWINGS

FIG. 1 is a perspective view of a disk brake according to a first representative embodiment of the present invention; and

FIG. 2 is a plan view of the disk brake; and

FIG. 3 is a cross-sectional view taken along line III-III in FIG. 2; and

FIG. 4 is a front view of an inner pad of the disk brake; and

FIG. 5 is a front view of an outer pad of the disk brake; and

FIG. 6 is a front view of an inner pad of a disk brake according to a second representative embodiment; and

FIG. 7 is a front view of an outer pad of the disk brake; and

FIG. 8 is a cross-sectional view taken along line VIII-VIII in FIG. 6; and

FIG. 9 is a front view of an inner pad of a disk brake according to a third representative embodiment; and

FIG. 10 is a front view of an outer pad of the disk brake; and

FIG. 11 is a front view of an inner pad of a disk brake according to a fourth representative embodiment; and

FIG. 12 is a front view of an outer pad of the disk brake.

### DETAILED DESCRIPTION OF THE INVENTION

Each of the additional features and teachings disclosed above and below may be utilized separately or in conjunction with other features and teachings to provide improved disk brakes and methods of manufacturing such disk brakes. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### First Representative Embodiment

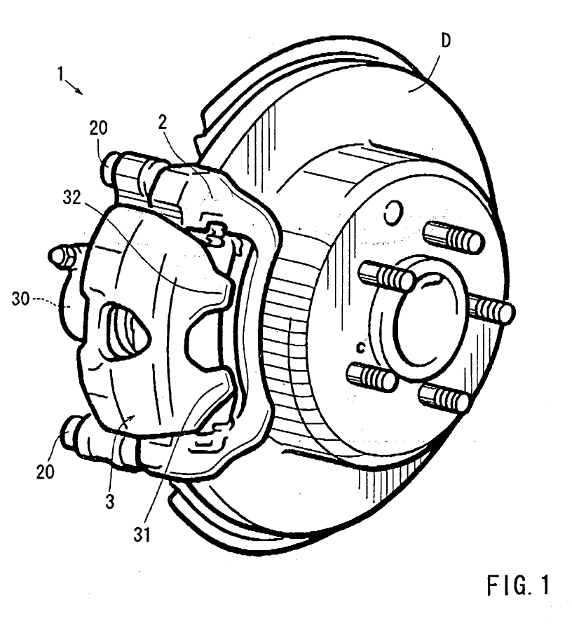

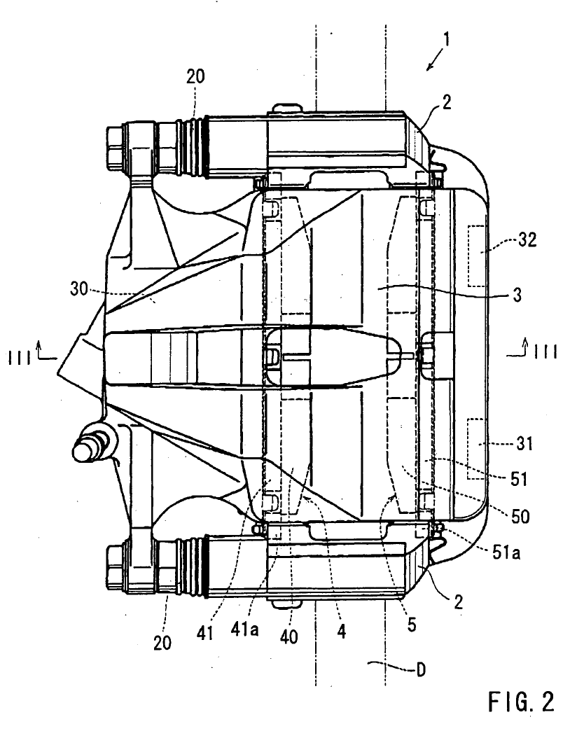

A first representative embodiment of the present invention will now be described with reference to FIGS. 1 to 5. Referring to FIG. 1, a disk brake 1 is configured as a floating type disk brake and generally includes a mounting 2 configured to be mounted to a vehicle body (not shown), a caliper 3 movably supported by the mounting 2, and two pads, i.e., an inner pad 4 and an outer pad 5 (see FIG. 2).

As shown in FIG. 2, the caliper 3 is supported by the mounting 2 via a pair of slide pins 20. Consequently, the caliper 3 can move relative to the mounting 2 in a direction parallel to the axis of a brake disk D. More specifically, as shown in FIG. 1 the caliper 3 is positioned on a radially outer side of the outer periphery of the brake disk D, straddling the brake disk D in a direction parallel to the axis of the brake disk D. A piston 30 is mounted in the caliper 3 on an axially inner side (i.e., the left side as viewed in FIG. 2) of the caliper 3 with respect to a vehicle body (not shown). Two caliper claws 31 and 32 are formed on the caliper 3 on an axially outer side (i.e., the right side as viewed in FIG. 2) thereof.

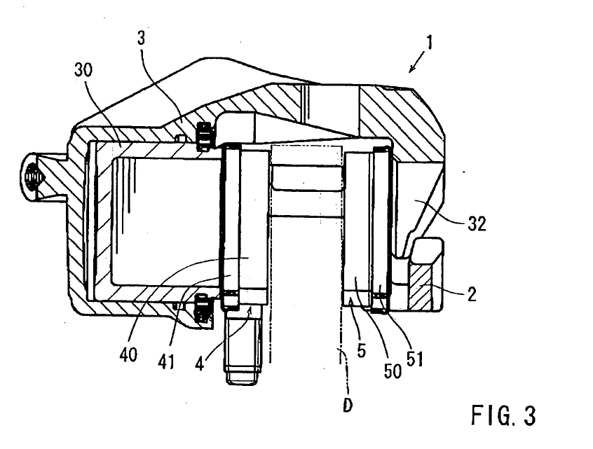

As shown in FIG. 3, the piston 30 is disposed on the axially inner side of the inner pad 4 and functions so as to press the inner pad 4 against an axially inner surface (i.e., the left side surface as viewed in FIG. 3) of the brake disk D. As shown in FIG. 1, each of the caliper claws 31 and 32 extends in a cantilever manner in a direction from the radially outer side of the brake disk D towards the central axis of the brake disk D, so as to oppose the axially outer surface of the outer pad 5. Therefore, when the piston 30 is actuated to press the inner pad 4 against the axially inner surface of the brake disk D, the caliper 3 may move in a direction towards the axially inner side as a result of a reaction force to the pressing force, so that the caliper claws 31 and 32 may press the outer pad 5 against the axially outer surface of the brake disk D.

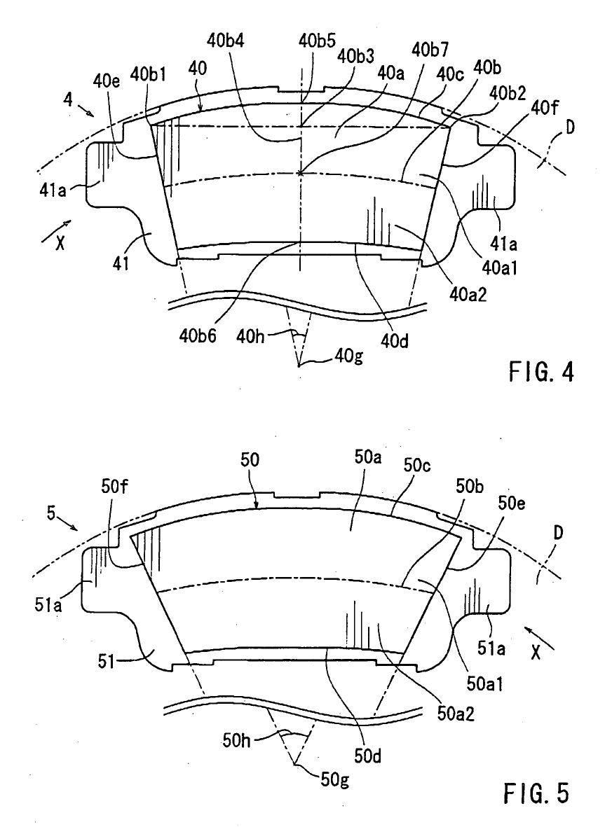

As shown in FIG. 4, the inner pad 4 has a back plate 41 and a friction member 40. The back plate 41 is adapted to support the friction member 40 from the side of a back surface (i.e., the left surface as viewed in FIG. 3) of the friction member 40. The back plate 41 has a pair of tabs 41a that extend outward in a circumferential direction from opposite circumferential ends of the back plate 41. Guide portions, configured as recesses formed in the mounting 2, axially movably support the tabs 41a so that the back plate 41 is axially movable relative to the mounting 2. Similarly, as shown in FIG. 5, the outer pad 5 has a back plate 51 and a friction member 50. The back plate 51 is adapted to support the friction member 50 from the side of a back surface (i.e., the right surface as viewed in FIG. 3) of the friction member 50. The back plate 51 has a pair of tabs 51a that extend outward in a circumferential direction from opposite circumferential ends of the back plate 51. Guide portions, configured as recesses formed in the mounting 2, axially movably engage the tabs 51a so that the back plate 51 is axially movable relative to the mounting 2.

As shown in FIG. 4, the friction member 40 has a slide contact surface 40a adapted to produce a friction force against the rotation of the brake disk D when pressed against a surface of the brake disk D. The slide contact surface 40a has a substantially sectoral configuration (i.e., in this case, a pie shaped section bounded by an inner and outer arc and two radial lines) and has a radially outer circumferential edge 40c and a radially inner circumferential edge 40d. The radially outer circumferential edge 40c extends along the radially outer circumferential edge of the brake disk D. The radially inner circumferential edge 40d extends along a circumferential direction of the brake disk D along a radially inner circumference of the brake disk D relative to the radially outer circumferential edge 40c. Similarly, as shown in FIG. 5, the friction member 50 has a slide contact surface 50a adapted to produce a friction force against the rotation of the brake disk D when pressed against a surface of the brake disk D. The slide contact surface 50a has a substantially sectoral configuration (i.e., in this case, a pie shaped section bounded by an inner and outer arc and two radial lines) and has a radially outer circumferential edge 50c and a radially inner circumferential edge 50d. The radially outer circumferential edge 50c extends along the radially outer circumferential edge of the brake disk D. The radially inner circumferential edge 50d extends along a circumferential direction of the brake disk D along a radially inner circumference of the brake disk D relative to the radially outer circumferential edge 50c. In this representative embodiment, the radially outer circumferential edges 40c and 50c and the radially inner circumferential edges 40c and 50d of the friction members 40 and 50 are substantially configured to extend along arcs. However, they may be configured to extend along straight lines.

The slide contact surface 40a has a first circumferential edge 40e and a second circumferential edge 40f extending in radial directions and positioned opposite to each other in a circumferential direction. The first circumferential edge 40e is positioned on the side of the friction member 40 opposite to the rotational direction of the brake disk D. The circumferential edge 40f is positioned on the side of the friction member 40 in the rotational direction of the brake disk D. An arrow X indicates the rotational direction of the brake disk D in FIG. 4. Therefore, the first circumferential edge 40e and the second circumferential edge 40f will be hereinafter also respectively called “rotation-in-side edge 40e” and “rotation-out-side edge 40f.” Similarly, the slide contact surface 50a has a first circumferential edge 50e and a second circumferential edge 50f extending in radial directions and positioned opposite to each other in a circumferential direction. The first circumferential edge 50e is positioned on the side of the friction member 50 opposite to the rotational direction of the brake disk D. The circumferential edge 40f is positioned on the side of the friction member 50 in the rotational direction of the brake disk D (see FIG. 5). Therefore, the first circumferential edge 50e and the second circumferential edge 50f will also be hereinafter respectively called “rotation-in-side edge 50e” and “rotation-out-side edge 50f.” In this representative embodiment, the rotation-in-side edges 40c and 50e and the rotation-out-side edges 40f and 50f of the friction members 40 and 50 are configured to extend along straight lines. However, the edges may extend along arcs.

In the case that the rotation-in-side edges 40e and 50e and the rotation-out-side edges 40f and 50f of the friction members 40 and 50 extend along straight lines, as in this representative embodiment, the lines extending along the rotation-in-side edge 40e and the rotation-out-side edge 40f may intersect at a point 40g radially inward of the friction member 40. The lines extending along the rotation-in-side edge 50e and the rotation-out-side edge 50f may intersect at a point 50g radially inward of the friction member 50. If the rotation-in-side edges 40e and 50e and the rotation-outside edges 40f and 50f of the friction members 40 and 50 do not extend along straight lines, virtual average straight lines or average linear lines may be determined such that the average linear lines of the rotation-in-side edge 40e (50e) and the rotation-out-side edge 40f (50f) intersect at the point 40g (50g). Thus, in this case, the slide contact surfaces 40a (50a) may have a substantially sectoral configuration.

As shown in FIGS. 4 and 5, the length of the outer circumferential edge 40a (50a) of The slide contact surface 40a (50a) is longer than the length of the inner circumferential edge 40d (50d). In addition, the area of a radially outer region 40a1 (50a1), determined with respect to a central circumferential line 40b (50b), of the slide contact surface 40a (50a) is greater than the area of a radially inner region 40a (50a2).

The central circumferential line 40b may be determined in such a manner as will be hereinafter described. First, as shown in FIG. 4, points 40b1 and 40b2 are determined that are spaced apart from each other by the longest distance in a circumferential direction within the slide contact surface 40a. Then, a line 40b4 (defining a central line with respect to the circumferential direction and also called a “width central line”) may be drawn in the radial direction from a central point 40b3 of a linear line connecting the points 40b1 and 40b2. Subsequently, a point 40b5 may be determined where the line 40b4 intersects with the outer circumferential edge 40c, and a point 40b6 may be determined where the line 40b4 intersects with the inner circumferential edge 40d. Thereafter, a central point 40b7 may be determined (defining a central point with respect to the radial direction) of the line connecting the point 40b5 and the point 40b6. The central circumferential line 40b may then be drawn in a circumferential direction so as to pass through the central point 40b7. The central circumferential line 50b of the slide contact surface 50a may be determined in the same manner as the central circumferential line 40b of the slide contact surface 40a.

As will be seen from a comparison between FIG. 4 and FIG. 5, the configurations of the friction members 40 of the inner pad 4 and the friction members 50 of the outer pad 50 are different from each other in the following points. First, the ratio of the area of the radially outer region 50a1 to the area of the radially inner region 50a2 of the slide contact surface 50a is greater than the ratio of the area of the radially outer region 40a1 to the area of the radially inner region 40a2 of the slide contact surface 40a However, the area of the radially outer region 40a1 (50a1) of the friction member 40 (50) is greater than the area of the radially inner region 40a2 (50a2).

Further, the ratio of the length of the outer circumferential edge 50c to the length of the inner circumferential edge 50d of the friction member 50 is greater than the ratio of the length of the outer circumferential edge 40c to the length of the inner circumferential edge 40d of the friction member 40. However, the length of the outer circumferential edge 40c (50c) of the friction member 40 (50) is longer than the length of the inner circumferential edge 40d (50d).

Additionally, an angle 50h, determined between the lines (i.e., the average linear lines) extending along the rotation-in-side edge 50c and the rotation-out-side edge 50f at the intersecting point 50g at a radially inward side, is larger than an angle 40h between the lines (i.e., the average linear lines) extending along the rotation-in-side edge 40e and the rotation-out-side edge 40f at the intersecting point 40g. In other words, the central angle of the outer pad 5 is greater than the central angle of the inner pad 4.

In this representative embodiment, the overall area of the slide contact surface 40a is set to be equal to the overall area of the slide contact surface 50a. However, the overall areas of the slide contact surfaces 40a and 50a may differ from each other.

As described above, according to the representative disk brake 1, the inner pad 4 and the outer pad 5 respectively have slide contact surfaces 40a and 50a that are adapted to frictionally slidably contact with opposite surfaces of the brake disk D. The area of the outer circumferential region 40a1 (50a1) of the slide contact surface 40a (50a) is greater than the area of the inner circumferential region 40a2 (50a2). In addition, the ratio of the area of the outer circumferential region 50a1 to the area of the inner circumferential region 50a2 of the outer pad 5 is greater than the ratio of the outer circumferential region 40a1 to the area of the inner circumferential region 40a2 of the inner pad 4.

In general, the contact area of an outer circumferential region of a slide contact surface of an inner or outer pad with a brake disk is greater than a contact area of an inner circumferential region of the slide contact surface, due to the change in length in the circumferential direction of the brake disk along the radial direction. However, in the above representative embodiment, the area of the outer circumferential region 40a1 (50a1) of the slide contact surface 40a (50a) is greater than the area of the inner circumferential region 40a2 (50a2). In other words, the pressure per unit area applied by the outer circumferential region 40a1 (50a1) may be smaller than the pressure per unit area applied by the inner circumferential region 40a2 (50a2). Therefore, the amount of abrasion per unit area of the outer circumferential region 40a1 (50a1) may be substantially equal to the amount of abrasion per unit area of the inner circumferential region 40a2 (50a2). As a result, non-uniform abrasion of the slide contact surface 40a (50a) with respect to the radial direction of the brake disk D can be prevented or minimized.

In addition, as shown in FIG. 1, each of the caliper claws 31 and 32 extends in a cantilever manner for pressing the outer pad 5 against the brake disk D. Therefore, during the application of a pressing force to the outer pad 5, the caliper claws 31 and 32 may tend to warp about their base ends located on the side of the caliper 3. As a result, the outer circumferential region 50a1 of the outer pad 5 may be pressed against the brake disk D with a greater force than the inner circumferential region 50a2. However, according to the representative embodiment the ratio of the area of the outer circumferential region 50a1 to the area of the inner circumferential region 50a2 of the outer pad 5 is greater than the ratio of the area of the outer circumferential region 40a1 to the area of the inner circumferential region 40a2 of the inner pad 4. Therefore, the pressure per unit area applied by the outer circumferential region 50a1 may be reduced to prevent or m non-uniform abrasion even if the caliper claws 31 and 32 have been warped. As a result, non-uniform abrasion of the outer pad 5 may be prevented or at least minimized to the same extent as the non-uniform abrasion that may be caused in the inner pad 4, if any. In other words, non-uniform abrasion of the outer pad 5 may be reduced to at least the same level as that of the inner pad 4.

Further, because non-uniform abrasion of the inner pad 4 is prevented or minimized as described above, it is possible to prevent or minimize the potential inclination of the inner pad 4 relative to the piston 30. This inclination may otherwise be caused when the inner pad 4 is pressed against the brake disk D. Also, because non-uniform abrasion of the outer pad 5 is prevented or minimized as described above, it is possible to prevent or minimize the potential inclination of the outer pad 5 relative to the caliper claws 31 and 32. The inclination of the outer pad 5 may also be otherwise caused when the outer pad 5 is pressed against the brake disk D. Therefore, during the braking operation of the disk brake 1 it is possible to minimize the frictional resistance between the inner pad 4 and the piston 30 as well as the frictional resistance between the outer pad 5 and the caliper claws 31 and 32.

Furthermore, because non-uniform abrasion of the inner pad 4 (outer pad 5) can be prevented or minimized, it is possible to reliably prevent possible displacement of the pressure center of the inner pad 4 (outer pad 5) during a braking operation. Therefore, the generation of unusual sounds or brake vibrations can be prevented or minimized.

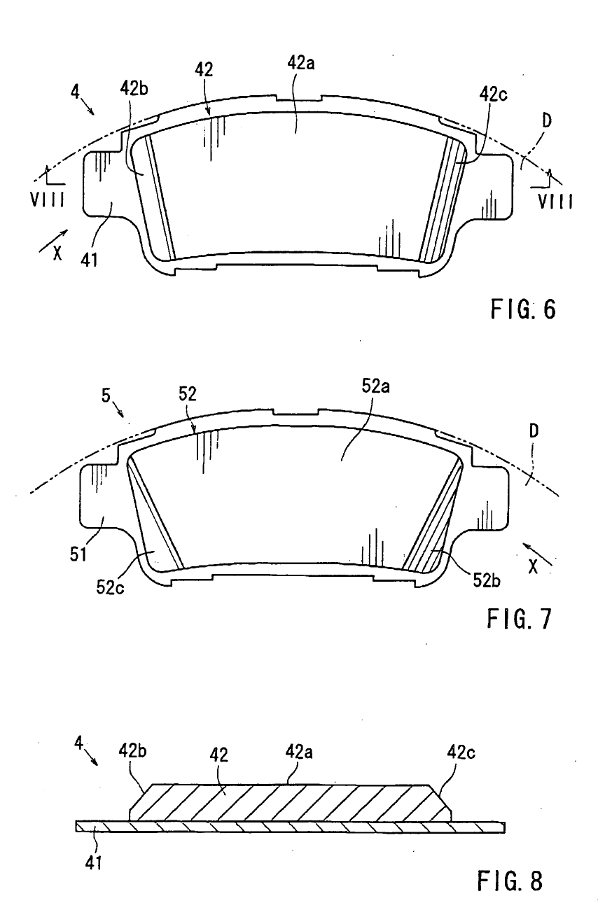

The second to fourth representative embodiments will now be described with reference to FIGS. 6 to 12. These representative embodiments are modifications of the first representative embodiment. Therefore, in FIGS. 6 to 12, like members are given the same reference numbers as in the fast representative embodiment and the description of these members may not be repeated.

### Second Representative Embodiment

The second representative embodiment will now be described with reference to FIGS. 6 to 8. The second representative embodiment differs from the first representative embodiment only in that the friction member 40 of the inner pad 4 and the friction member 50 of the outer pad 5 (shown in FIGS. 4 and 5) are respectively replaced with a friction member 42 and a friction member 52 shown in FIGS. 6 and 7. Therefore, the second representative embodiment will be described primarily with regard to the different constructions.

As shown in FIG. 6, the friction member 42 has a slide contact surface 42a and two chamfered portions 42b and 42c. Similarly, as shown in FIG. 7, the friction member 52 has a slide contact surface 52b and two chamfered portions 52b and 52c. As respectively shown in FIGS. 6 and 7, the slide contact surface 42a and the slide contact surface 52a have substantially the same outer contours as the slide contact surface 40 and the slide contact surface 50, when viewed in the axial direction of the brake disk D.

The chamfered portions 42b and 52b are respectively positioned at the circumferential edges on the side of the friction members 42 and 52 opposite to the rotational direction X (i.e., rotation-in-side) of the slide contact surfaces 42a and 52a. Conversely, the chamfered portions 42c and 52c are respectively positioned at the circumferential edges on the side of the friction members 42 and 52 in the rotational direction X (i.e., rotation-out-side) of the slide contact surfaces 42a and 52a.

As shown in FIG. 8, the chamfered portions 42b and 42c are configured as inclined surfaces respectively extending outward toward the back plate 41. Similarly, the chamfered portions 52b and 52c are configured as inclined surfaces respectively extending outward toward the back plate 51.

### Third Representative Embodiment

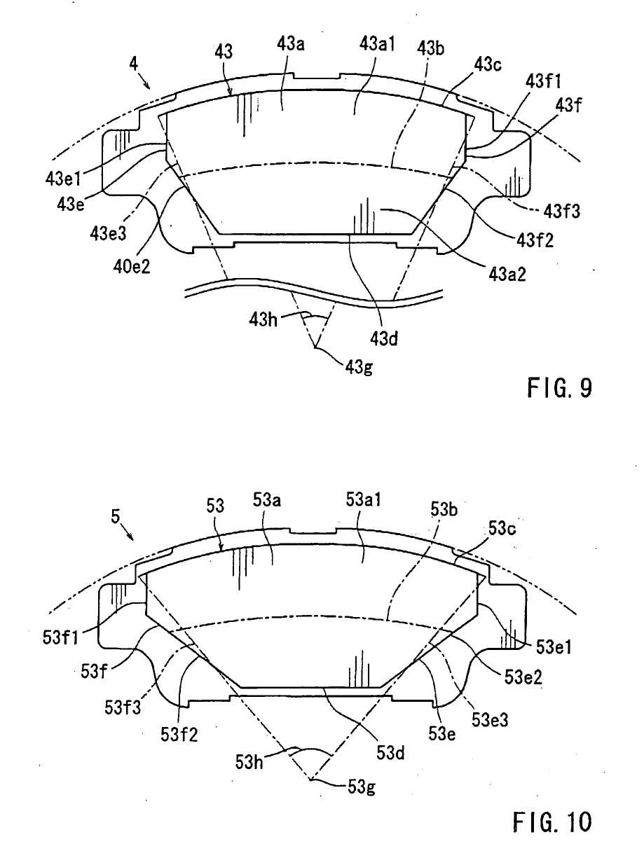

The third representative embodiment will now be described with reference to FIGS. 9 and 10. The third representative embodiment differs from the fist representative embodiment only in that the friction member 40 of the inner pad 4 and the friction member 50 of the outer pad 5 shown in FIGS. 4 and 5 are respectively replaced with a friction member 43 and a friction member 53 shown in FIGS. 9 and 10. Therefore, the third representative embodiment will be described primarily with regard to the different construction.

As shown in FIGS. 9 and 10, the friction members 43 and 53 respectively have slide contact surfaces 43a and 53a having substantially sectoral configurations (i.e., in this case, pie shaped sections bounded by an outer arc and five straight edges). The slide contact surface 43a has an outer circumferential edge 43c and an inner circumferential edge 43d. Similarly, the slide contact surface 53a has an outer circumferential edge 53c and an inner circumferential edge 53d. The outer circumferential edges 43c and 53c extend along arcs, while the inner circumferential edges 43d and 53d extend along substantially straight lines.

The slide contact surface 43a also has a rotation-in-side edge 43e and a rotation-out-side edge 43f on the opposite sides of the friction member 43 in the circumferential direction. Similarly, the slide contact surface 53a also has a rotation-in-side edge 53e and a rotation-out-side edge 53f on the opposite sides of the friction member 53 in the circumferential direction. In this representative embodiment, the rotation in-side-edges 43e and 53e and the rotation-out-side edges 43f and 53f extend substantially in a radial direction but are bent at intermediate positions. More specifically, the rotation-in-side edge 43e has linear edge portions 43e1 and 43e2, respectively positioned on the radially outer side and the radially inner side. Similarly, the rotation-out-side edge 43f has linear edge portions 43f1 and 43f2, respectively positioned on the radially outer side and the radially inner side. Further, the rotation-in-side edge 53e has linear edge portions 53e1 and 53e2, respectively positioned on the radially outer side and the radially inner side. The rotation-out-side edge 53f has linear edge portions 53f1 and 53f2, respectively positioned on the radially outer side and the radially inner side. The radially inner side linear edge portions 43e2, 43f2, 53e2, and 53f2, are inclined relative to the radial direction by an angle that is larger than an angle of inclination of the radially inner side linear edge portions 43e1, 43f1, 53e1, and 53e2, relative to the radial direction. In addition, the direction of inclination of the radially inner side linear edge portions 43e2, 43f2, 53e2, and 53f2, is opposite to the direction of inclination of the radially inner side linear edge portions 43e1, 43f1, 53e1, and 53e2. Therefore, the slide contact surface 43a (53a) is incrementally tapered in a direction from the outer circumferential edge 43c (53c) toward the inner circumferential edge 43d (53d).

An average linear line 43e3 (i.e., a virtual average straight line) of the rotation-in-side edge 43e and an average linear line 43f3 of the rotation-out-side edge 43f intersect with each other at a point 43g at a radially inward side. Similarly, an average linear line 53e3 (i.e., a virtual average straight line) of the rotation-in-side edge 53e and an average linear line 53f3 of the rotation-outside edge 53f intersect with each other at a point 53g at a radially inward side.

Similar to the first representative embodiment, an angle 53h, determined between the lines (i.e., the average linear lines) extending along the rotation-in-side edge 53c and the rotation-out-side edge 53f at the intersecting point 53g, is larger than an angle 43h, determined between the lines (i.e., the average linear lines) extending along the rotation-in-side edge 43e and the rotation-out-side edge 43f at the intersecting point 43g.

Also, the area of an outer circumferential region 43a1 (53a1) of the slide contact surface 43a (53a) is greater than the area of an inner circumferential region 43a2 (53a2). In addition, the ratio of the area of the radially outer region 53a1 to the area of the radially inner region 53a2 of the slide contact surface 53a is greater than the ratio of the area of the radially outer region 43a1 to the area of the radially inner region 43a2 of the slide contact surface 43a

Further, the length of the outer circumferential edge 43c (53c) is longer than the length of the inner circumferential edge 43d (53d). The ratio of the length of the outer circumferential edge 53c to the length of the inner circumferential edge 53d of the friction member 53 is greater than the ratio of the length of the outer circumferential edge 43c to the length of the inner circumferential edge 43d of the friction member 43.

### Fourth Representative Embodiment

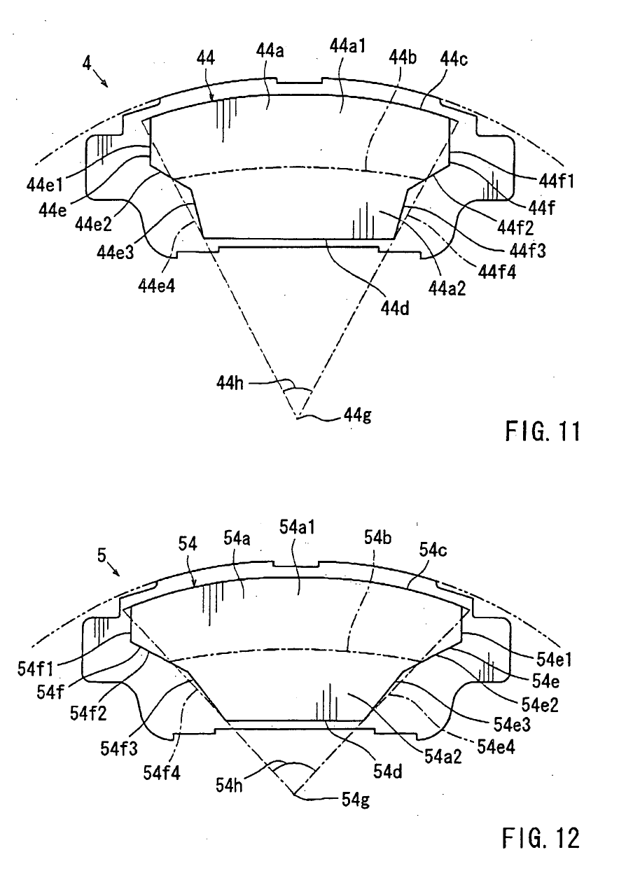

The fourth representative embodiment will now be described with reference to FIGS. 11 and 12. The fourth representative embodiment differs from the first representative embodiment only in that the friction member 40 of the inner pad 4 and the friction member 50 of the outer pad 5 shown in FIGS. 4 and 5 are respectively replaced with a friction member 44 and a friction member 54 shown in FIGS. 11 and 12. Therefore, the fourth representative embodiment will be described primarily with regard to the different constructions.

As shown in FIGS. 11 and 12, the friction members 44 and 54 respectively have slide contact surfaces 44a and 54a. The slide contact surface 44a has an outer circumferential edge 44c and an inner circumferential edge 44d. Similarly, the slide contact surface 54a has an outer circumferential edge 54c and an inner circumferential edge 54d. The outer circumferential side edges 44c and 54c extend along arcs, while the inner circumferential edges 44d and 54d extend along substantially straight lines.

The slide contact surface 44a also has a rotation-in-side edge 44e and a rotation-out-side edge 44f on the opposite sides of the fiction member 44 in the circumferential direction Similarly, the slide contact surface 54a also has a rotation-in-side edge 54e and a rotation-out-side edge 54f on the opposite sides of the friction member 54 in the circumferential direction. In this representative embodiment, each of the rotation in-side-edges 44e and 54e and the rotation-out-side edges 44f and 54f extends substantially in the radial direction but is bent at two intermediate positions. More specifically, the rotation-in-side edge 44e (54e) has a first linear edge portion 44e1 (54e1), a second linear edge portion 44e2 (54e2), and a third linear edge portion 44e3 (54e3), arranged in this order in a direction from the outer circumferential edge 44c (54c) towards the inner circumferential edge 44d (54d). Similarly, the rotation-out-side edge 44f (54f) has a first linear edge portion 44f1 (54f1), a second linear edge portion 44f2 (54f2), and a third linear edge portion 44f3 (54f3), arranged in this order in a direction from the outer circumferential edge 44c (54c) towards the inner circumferential edge 44d (54d). In addition, the direction of inclination of the first linear edge portion 44e1 (44f1, 54e1, 54f1), the direction of inclination of the second linear edge portion 44e2 (44f2, 54e2, 54f2), and the direction of inclination of the third linear edge portion 44e3 (44f3, 54e3, 54f3) are alternately inclined to each other with respect to the radial direction. Further, the angle of inclination of the second linear edge portion 44e2 (44f2, 54e2, 54f2) is greater than the angle of the first linear edge portion 44e1 (44f1, 54e1, 54f1) and the angle of inclination of the third linear edge portion 44e3 (44f3, 54e3, 54f3).

An average linear line 44e4 (i.e., a virtual average straight line) of the rotation-in-side edge 44e and an average linear line 44f4 of the rotation-out-side edge 44f intersect one another at a point 44g on a radially inner side. Similarly, an average linear line 54e (i.e., a virtual average straight line) of the rotation-in-side edge 54e and an average linear line 54f4 of the rotation-out-side edge 54f intersect each other at a point 54g at a radially inward side.

Similar to the first representative embodiment, an angle 54h, determined between the lines (i.e., the average linear lines) extending along the rotation-in-side edge 54e and the rotation-out-side edge 54f at the intersecting point 54g, is larger than an angle 44h, determined between the lines (i.e., the average linear lines) extending along the rotation-in-side edge 44e and the rotation-out-side edge 44f at the intersecting point 44g.

Also, the area of an outer circumferential region 44a1 (54a1) of the slide contact surface 44a (54a) is greater than the area of an inner circumferential region 44a2 (54a2). In addition, the ratio of the area of the radially outer region 54a1 to the area of the radially inner region 54a2 of the slide contact surface 54a is greater than the ratio of the area of the radially outer region 44a1 to the area of the radially inner region 44a of the slide contact surface 44a.

Further, the length of the outer circumferential edge 44c (43c) is longer than the length of the inner circumferential edge 44d (54d). The ratio of the length of the outer circumferential edge 54c to the length of the inner circumferential edge 54d of the friction member 54 is greater than the ratio of the length of the outer circumferential edge 44c to the length of the inner circumferential edge 44d of the friction member 44.

### Other Possible Embodiments

The present invention may not be limited to the first to fourth representative embodiments but may be modified in various ways. For example, one of the first to fourth representative embodiments may be combined with the other embodiment(s).

The fourth representative embodiment was shown with the rotation-in-side edge and the rotation-out-side edge each comprising three segments. However, the teaching of the current invention is not limited to three segments per edge and can be expanded to four or more segments.

1. A disk brake comprising:
a brake disk and
a caliper disposed on a radially outer side of the brake disk and extending in an axial direction of the brake disk so as to substantially straddle the brake disk, and
a piston disposed on a first side of the caliper with respect to the axial direction of the brake disk, and
a first pad arranged and constructed to be pressed against a first axial surface of the brake disk by actuation of the piston; and
at least one caliper claw disposed on a second side of the caliper opposite to the first side of the caliper and movable with the caliper via a reaction force produced when the piston is actuated; and
a second pad arranged and constructed to be pressed against a second axial surface of the brake disk opposite to the first axial surface of the brake disk by movement of the at least one caliper claw;
wherein each of the at least one caliper claw extends in a cantilever manner in a direction from an outer circumferential side of the brake disk toward a central side of the brake disk; and
wherein each of the first pad and the second pad respectively have a slide contact surface for slidably contacting with the first and second axial surfaces of the brake disk; and
wherein each of the slide contact surfaces has an outer circumferential region and an inner circumferential region delimited by a central circumferential line passing through a central point with respect to a circumferential direction and also with respect to a radial direction of the corresponding pad; and
wherein each of the outer circumferential regions is greater than the corresponding inner circumferential region; and
wherein a ratio of the outer circumferential region to the corresponding inner circumferential region of the second pad is greater than a ratio of the outer circumferential region to the corresponding inner circumferential region of the first pad.

2. The disk brake as in claim 1, wherein a difference between the ratio of the outer circumferential region to the inner circumferential region of the second pad and the ratio of the outer circumferential region to the inner circumferential region is determined so as to eliminate a potential unbalance between a distribution of abrasion of the slide contact surface of the second pad and a distribution of abrasion of the slide contact surface of the first pad due to a change of distribution of pressure applied to the second pad by the at least one caliper claw.

3. The disk brake as in claim 1, wherein the change of distribution of pressure is caused by a potential warp of the at least one caliper claw when the at least one caliper claw applies a pressing force to the second pad.

4. The disk brake as in claim 1,
wherein each of the outer circumferential regions has an outer circumferential edge; and
wherein each of the inner circumferential region has an inner circumferential edge; and
wherein the central point is a middle point between points where a radial central line of the slide contact surface intersects with the outer circumferential edge and the inner circumferential edge; and
wherein the radial central line is defined between remotest points that are spaced from each other by the longest distance in the circumferential direction within the slide contact surface.

5. The disk brake as in claim 4,
wherein each of the outer circumferential edge and the inner circumferential edge substantially extends along an arc.

6. The disk brake as in claim 4,
wherein the outer circumferential edge substantially extends along an arc and the inner circumferential edge substantially extends along a straight line.

7. The disk brake as in claim 4, wherein a length of the outer circumferential edge is longer than a length of the inner circumferential edge in each of the first and second pads; and
wherein a ratio of the length of the outer circumferential edge to the length of the inner circumferential edge of the second pad is greater than a ratio of the length of the outer circumferential edge to the length of the inner circumferential edge of the first pad.

8. The disk brake as in claim 1,
wherein each of the slide contact surfaces further includes a first side edge and a second side edge disposed on opposite sides of the corresponding slide contact surface in the circumferential direction; and
wherein the first side edge and the second side edge extend along radial lines extending substantially in a radial direction and intersecting with each other at a point radially inward of the corresponding slide contact surface; and
wherein an angle of intersection of the radial lines extending along the first side edge and the second side edge of the second pad is greater than an angle of intersection of the radial lines extending along the fist side edge and the second side edge of the fist pad.

9. A disk brake comprising:
a brake disk; and
a caliper disposed on a radially outer side of the brake disk and extending in an axial direction of the brake disk so as to substantially straddle the brake disk; and
a piston disposed on a first side of the caliper with respect to the axial direction of the brake disk and
a first pad arranged and constructed to be pressed against a first axial surface of the brake disk by actuation of the piston; and
at least one caliper claw disposed on a second side of the caliper opposite to the first side of the caliper and movable with the caliper via a reaction force produced when the piston is actuated; and
a second pad arranged and constructed to be pressed against a second axial surface of the brake disk opposite to the first axial surface of the brake disk via movement of the at least one caliper claw;
wherein each of the at least one caliper claws extends in a cantilever manner in a direction from an outer circumferential side of the brake disk towards a central side of the brake disk; and
wherein each of the first pad and the second pad respectively have a slide contact surface for contacting with the first and second axial surfaces of the brake disk; and
wherein each of the slide contact surfaces has an outer circumferential edge and an inner circumferential edge respectively positioned on a radially outer side and a radially inner side and extending in a circumferential direction; and
wherein a length of the outer circumferential edge is longer than a length of the inner circumferential edge in each of the first and second pads; and
wherein a ratio of the length of the outer circumferential edge to the inner circumferential edge of the second pad is greater than a ratio of the length of the outer circumferential edge to the inner circumferential edge of the first pad.

10. The disk brake as in claim 9, wherein a difference between the ratio of the outer circumferential edge to the inner circumferential edge of the second pad and the ratio of the outer circumferential edge to the inner circumferential edge of the first pad is determined so as to eliminate a potential unbalance between a distribution of abrasion of the slide contact surface of the second pad and a distribution of abrasion of the slide contact surface of the first pad due to a change of distribution of pressure applied to the second pad by the at least one caliper claws.

11. The disk brake as in claim 10, wherein the change of distribution of pressure is caused by a potential warp of the at least one caliper claw when the at least one caliper claw applies a pressing force to the second pad.

12. The disk brake as in claim 9,
wherein each of the slide contact surfaces has a first side edge and a second side edge disposed on opposite sides of the slide contact surface in the circumferential direction; and
wherein each of the first and second side edges extend along radial lines extending substantially in a radial direction and intersecting with each other at a point radially inward of the corresponding slide contact surface; and
wherein an angle of intersection of the radial lines extending along the first and second side edges of the second pad is greater than an angle of intersection of the radial lines extending along the first and second side edges of the first pad.

13. A disk brake comprising:
a brake disk; and
a caliper disposed on a radially outer side of the brake disk and extending in an axial direction of the brake disk so as to substantially straddle the brake disk; and
a piston disposed on a first side of the caliper with respect to the axial direction of the brake disk and
a first pad arranged and constructed to be pressed against a first axial surface of the brake disk by actuation of the piston; and
at least one caliper claw disposed on a second side of the caliper opposite to the first side of the caliper and movable with the caliper by a reaction force produced when the piston is actuated; and
a second pad arranged and constructed to be pressed against a second axial surface of the brake disk opposite to the first axial surface of the brake disk by movement of the at least one caliper claw;
wherein each of the at least one caliper claw extends in a cantilever manner in a direction from an outer circumferential side of the brake disk towards a central side of the brake disk; and
wherein each of the first pad and the second pad respectively have a slide contact surface for contacting with the first and second axial surfaces of the brake disk; and
wherein each of the slide contact surfaces has a first side edge and a second side edge disposed on opposite sides of the corresponding slide contact surface in a circumferential direction; and
wherein each of the first and second side edges extend along a corresponding radial line extending substantially in a radial direction and intersecting with each other at a point radially inward of the corresponding slide contact surface; and
wherein an angle of intersection of the radial lines extending along the first and second side edges of the second pad is greater than an angle of intersection of the radial lines extending along the first and second side edges of the first pad.

14. The disk brake as in claim 13, wherein a difference between the angle of intersection of the radial lines extending along the first and second side edges of the second pad and the angle of intersection of the radial lines extending along the fist and second side edges of the first pad is determined so as to eliminate a potential unbalance between a distribution of abrasion of the slide contact surface of the second pad and a distribution of abrasion of the slide contact surface of the first pad due to a change of distribution of pressure applied to the second pad by the at least one caliper claw.

15. The disk brake as in claim 14, wherein the change of distribution of pressure is caused by a potential warp of the at least one caliper claw when the at least one caliper claw applies a pressing force to the second pad.

16. The disk brake as in claim 13, wherein the first and second side edges of each of the first and second pads are chamfered so as to incline with respect to a surface of the corresponding pad.

17. The disk brake as in claim 13,
wherein each of the first and second side edges extends along a non-straight line; and
wherein the corresponding radial line of each of the first and second side edges is a virtual average radial line.

18. The disk brake as in claim 17,
wherein each of the first and second side edges extends along a line including a plurality of straight line portions joined in series with one another and inclined relative to each other.

19. A disk brake comprising:
a brake disk; and
a caliper disposed on a radially outer side of the brake disk and extending in an axial direction of the brake disk so as to substantially straddle the brake disk; and
a piston disposed on a first side of the caliper with respect to the axial direction of the brake disk; and
a first pad arranged and constructed to be pressed against a first axial surface of the brake disk by actuation of the piston; and
at least one caliper claw disposed on a second side opposite to the first side of the caliper and movable with the caliper by a reaction force produced when the piston is actuated; and
a second pad arranged and constructed to be pressed against a second axial surface opposite to the first axial surface of the brake disk by movement of the at least one caliper claw;
wherein each of the at least one caliper claw extends in a cantilever manner in a direction from an outer circumferential side of the brake disk towards a central side of the brake disk; and
wherein each of the first pad and the second pad respectively have a slide contact surface for contacting with the first and second axial surfaces of the brake disk; and
wherein each of the slide contact surfaces has an outer circumferential region and an inner circumferential region delimited by a central circumferential line passing through a central point with respect to a circumferential direction and also with respect to a radial direction of the corresponding pad; and
wherein each of the outer circumferential region is greater than the corresponding inner circumferential region; and
wherein a ratio of the outer circumferential region to the inner circumferential region of the second pad is greater than a ratio of the outer circumferential region to the inner circumferential region of the first pad; and
wherein each of the outer circumferential regions has an outer circumferential edge; and
wherein each of the inner circumferential regions has an inner circumferential edge; and
wherein a length of the outer circumferential edge is longer than a length of the inner circumferential edge in each of the first and second pads; and
wherein a ratio of the length of the outer circumferential edge to the length of the inner circumferential edge of the second pad is greater than a ratio of the length of the outer circumferential edge to the length of the inner circumferential edge of the first pad; and
wherein each of the slide contact surfaces has a first side edge and a second side edge disposed on opposite sides of the corresponding slide contact surface in the circumferential direction; and
wherein each of the first and second side edges extend along a corresponding radial line extending substantially in a radial direction and intersecting one another at a point radially inward of the corresponding slide contact surface; and
wherein an angle of intersection of the radial lines extending along the first and second side edges of the second pad is greater than an angle of intersection of the radial lines extending along the first and second side edges of the first pad.
